(19) United States
(12) Patent Application Publication
(10) Pub. No.: US 2011/0231215 A1
(43) Pub. Date: Sep. 22, 2011

(54) OPTIMIZATION OF A RESOURCE MATCHING MODEL BY MAPPING A MODEL TO A BIPARTITE GRAPH

(76) Inventors: Cipriano A. Santos, Modesto, CA (US); Shailendra K. Jain, Sunnyvale, CA (US); Maria Teresa Gonzalez Diaz, Mountain View, CA (US); Carlos Enrique Valencia Oleta, Mexico DF (MX)

(21) Appl. No.: 12/725,361

(22) Filed: Mar. 16, 2010

(51) Int. Cl. G06Q 10/00; G06F 17/10

(52) U.S. Cl. 705/7.12; 703/2

(57) ABSTRACT

Example embodiments disclosed herein relate to a mechanism for optimizing a resource matching model. In particular, a mechanism is provided to access, in a resource matching system, input data for a mixed integer programming (MIP) model, which may include resource data describing resources and demand data describing corresponding demand instances. Mechanisms are also provided to convert the MIP model to a binary integer programming (BIP) model by redefining the input data to unary data and to map the BIP model to a bipartite graph using the unary data. The resulting bipartite graph may include a number of nodes including a first set corresponding to the resources and a second set corresponding to the demand instances, and a number of edges corresponding to decision variables of the BIP model, each edge representing a potential allocation of a resource in the first set to a demand instance in the second set.

### BACKGROUND

In today's global economy, atypical corporation maintains thousands, if not hundreds of thousands, of employees. In order to remain competitive, a global corporation must employ a geographically distributed workforce with diverse skills and levels of experience. With the level of competition in the marketplace as high as ever, efficient and cost-effective utilization of this workforce is of the utmost importance.

In an effort to efficiently utilize the available workforce and to improve employee and customer satisfaction, many companies invest significant amounts of time and money in workforce optimization solutions. Such solutions often use a mathematical model to represent the resources of the company and the demand for those resources. By solving such a model in a manner that optimizes one or more variables, the company may determine an efficient plan for assigning employees to particular projects or endeavors.

As the average company size, workforce diversity, and need for accuracy have increased, the complexity of the workforce optimization problem has also increased. A company may include employees with different sets of technical skills, experience levels, and job titles. In addition, a company may face uncertain demand, such that the projects and corresponding tasks may also vary. Furthermore, in addition to a plan for assigning employees to projects, a company may also desire to determine a plan for hiring new employees or training current employees to fill a new role.

Consequently, as a general rule, the most effective workforce optimization models use a large number of variables and constraints and therefore require significant computing power and time to find an optimal solution. On the other hand, simpler models that use a smaller number of variables or constraints may provide a reduction in complexity, but often fail to deliver the required results.

Similar issues are present in a number of other optimization problems. As one example, an online personals website may seek to match individuals based on compatibility. As another example, a supplier may desire to determine an ideal plan for shipping products to customers from its various warehouses. Indeed, any problem requiring matching of resources and demand is suitable for mathematical modeling. As with workforce optimization problems, speed and accuracy are often mutually exclusive in solving these types of problems.

### BRIEF DESCRIPTION OF THE DRAWINGS

In the accompanying drawings, like numerals refer to like components or blocks. The following detailed description references the drawings, wherein:

FIG. 1 is a block diagram of an example of a resource matching system including a machine-readable storage medium encoded with instructions for optimizing a resource matching model;

FIG. 2 is a block diagram of an example of a resource matching system including a machine-readable storage medium encoded with instructions for optimizing a resource matching model based on a set of input data;

FIG. 3 is a flowchart of an example of a method for optimizing a resource matching model;

FIG. 4 is a flowchart of an example of a method for converting a mixed integer programming model to a corresponding binary integer programming model;

FIGS. 5A & 5B are flowcharts of an example of a method for creating a bipartite graph using a binary integer programming model;

FIG. 6A is an example data set of a mixed integer programming model;

FIG. 6B is an example data set of a binary integer programming model corresponding to the mixed integer programming model of FIG. 6A;

FIG. 6C is an example bipartite graph including a plurality of edges generated using the binary integer programming model of FIG. 6B; and

FIG. 6D is an example bipartite graph illustrating one matching of the bipartite graph of FIG. 6C.

### DETAILED DESCRIPTION

As described above, the process for finding an optimal solution to a resource allocation problem is typically a tradeoff between effectiveness of the solution and minimization of required computing resources and processing time. In contrast, various example embodiments described in detail herein relate to reframing a resource planning model in a manner that provides highly effective results, while significantly reducing the amount of time required to find a solution for the model.

In particular, various embodiments convert a mixed integer programming (MIP) model to a corresponding binary integer programming model (BIP) model, and then convert the BIP model to a corresponding bipartite graph. In some embodiments, the resulting bipartite graph represents all information contained in the original MIP model. A minimum cost matching for the bipartite graph may then be determined using available methods with an execution time that is orders of magnitude faster than finding a solution for the corresponding MIP model. Additional embodiments and applications will be apparent to those of skill in the art upon reading and understanding the following description.

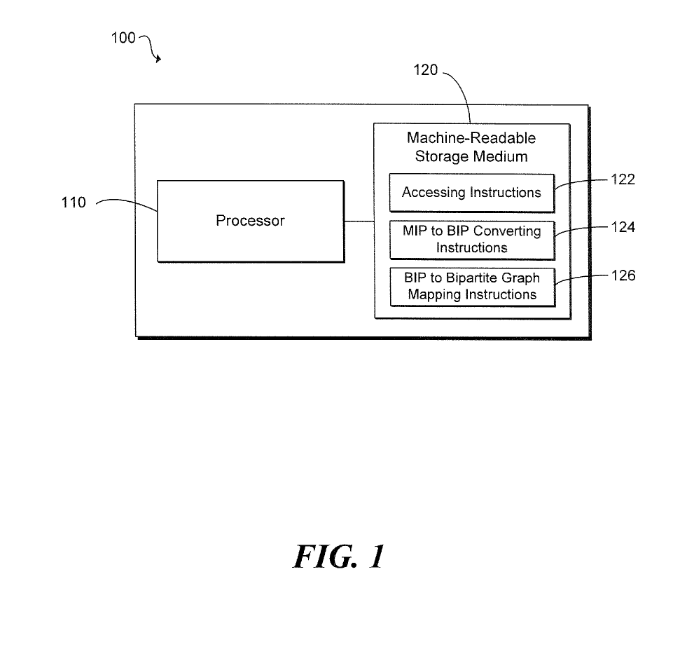

Referring now to the drawings. FIG. 1 is a block diagram of an example of a resource matching system 100 including a machine-readable storage medium 120 encoded with instructions for optimizing a resource matching model. Resource matching system 100 may be, for example, a desktop computer, a laptop computer, a server, a supercomputer, or any other hardware device suitable for execution of the instructions and processes described in detail below. In the embodiment of FIG. 1, resource matching system 100 includes a processor 110 and a machine-readable storage medium 120.

Processor 110 may be a central processing unit (CPU), a semiconductor-based microprocessor, or any other hardware device suitable for retrieval and execution of instructions stored in machine-readable storage medium 120. Machine-readable storage medium 120 may be an electronic, magnetic, optical, or other physical device that contains or stores executable instructions 122, 124, 126. Thus, processor 110 may fetch, decode, and execute accessing instructions 122, mixed integer programming (MIP) to binary integer programming (BIP) converting instructions 124, and BIP to bipartite graph mapping instructions 126, each described in further detail below.

Accessing instructions 122 may access input data for a mixed integer programming model. A MIP model may be a mathematical model used for maximizing or minimizing a linear objective function, subject to linear equality or inequality constraints. More specifically, in mathematical terms, the MIP model may be expressed in the following form:
Maximize/Minimize c^{T}x
Subject to Ax≦b,
   where x is a vector of decision variables, at least a subset of which are integers, c and b are vectors of known coefficients, and A is a matrix of known coefficients. Thus, an optimal solution for a MIP model is a vector of variables, x, for which all constraints are satisfied, while the objective function is minimized or maximized, depending on the problem.

The input data used in the MIP model may include resource data describing a number of resources. A resource may be any person, service, object, commodity, or other entity to be matched to a corresponding demand. For example, when the resource matching model relates to a workforce allocation problem, the resource data may identify a number of employees and their qualifications for specific jobs. Other examples include drivers available for delivery of items, classes open for registration, and individuals seeking a romantic partner. Other suitable sets of resource data will be apparent to those of skill in the art depending on the particular problem to be solved.

The input data may also include demand data describing a number of demand instances corresponding to demand for the resources. A demand may be any need that may be fulfilled by a corresponding resource. Referring again to an example of a workforce allocation problem, the demand data may identify specific jobs or tasks for which employees are required and a number of employees required for each job or task. Other demand examples corresponding to the resources described above include customers seeking delivery of an item, students registering for classes, and other individuals who are also seeking a romantic partner. Again, corresponding demand data will be apparent to those of skill in the art depending on the particular problem to be solved.

MIP to BIP converting instructions 124 may convert the MIP model into a corresponding binary integer programming model by redefining the input data to corresponding unary data. In particular, in the unary data, each resource may be able to satisfy a single demand instance, while each demand instance may be satisfied by a single resource. Thus, a BIP model may be similar to a MIP model, but each variable may be one of two possible values (i.e., “0” or “1”). In order to convert the MIP model into a corresponding BIP model, each resource or demand instance may be redefined such that each variable used in one or more of the constraints may be expressed as one of two possible values.

Thus, for any input data, converting instructions 124 may convert the input data to a set of unary data, such that all decision variables of the integer problem may be expressed as binary values. A decision variable may be an unknown quantity for which the model is designed to solve. As one example, suppose the demand instances each specify a number of resources required as a positive integer (i.e., 1, 2, 3, etc.). In such a case, converting instructions 124 may create a plurality of unary demand instances equal to the number of resources specified in the demand instance. Thus, in this example, the decision variables in the MIP model may require more than two values, while the corresponding decision variable in the BIP model could be expressed in terms of only two values (i.e., “1” or “0”). Similarly, if a particular resource is available to satisfy a plurality of demand instances, converting instructions 124 may create a corresponding plurality of single resources.

To give a more specific example, suppose a MIP demand instance is a job requirement, which specifies that three total employees are required for the job. In solving the corresponding MIP model, at least one decision variable would be used to keep track of the number of employees assigned to the task. To avoid this, converting instructions 124 may create three single job requirements, such that each job is either filled or not. Similarly, if a particular employee could be assigned to two tasks simultaneously, converting instructions 124 may create two single resources, each corresponding to one of the two tasks to which the employee can be assigned.

Finally, BIP to bipartite graph mapping instructions 126 may map the unary data into a corresponding bipartite graph. A bipartite graph may be a graph comprising two sets of disjoint nodes, such that each node in the first set is coupled to a corresponding node in a second set. In other words, a bipartite graph is a graph that contains only even-length cycles.

Using the unary data determined by converting instructions 124, mapping instructions 126 may create a graph containing two sets of nodes, one set corresponding to the resources and one set corresponding to the demand instances. Mapping instructions 126 may then create a plurality of edges, with each edge extending between a node in the set of resources and a node in the set of demand instances. Each of the created edges may correspond to a decision variable in the BIP model and may represent a potential allocation of a resource to a corresponding demand instance that may be satisfied by that resource. In other words, based on the converting instructions 124, each demand instance may be expressed as either satisfied or not and mapping instructions 126 may create an edge for each such instance. As described in detail below, when a matching is determined for the bipartite graph, if an edge is included in the matching, the value of the corresponding decision variable is “1,” while the value is “0” if the edge is not included in the matching.

In addition, in some embodiments, mapping instructions 126 may assign a cost to each edge in the bipartite graph. Such a cost may be based on a plurality of predetermined constants, with one or more constants used for each edge. For example, when the graph relates to assignment of a particular employee to a given job, the costs for an edge may be proportionate to a cost of assigning an employee, a cost of training the employee, if necessary, and the like. Additional examples of the assignment of costs are described in further detail below.

After mapping instructions 126 have created a bipartite graph and assigned any associated costs, any of a number of methods may be used to find a minimum-cost (or maximum-cost) matching for the graph, which may comprise a plurality of edges without common vertices. As will be apparent to those of skill in the art, the optimal matching problem for a graph may also be referred to as an assignment problem. Examples of suitable methods for solving such problems include the Kuhn-Munkres Algorithm (or Hungarian method), the simplex method or interior point method to solve LP problems, genetic algorithms, or any other method for solving such problems. In this manner, each edge in the matching may correspond to assignment of a particular resource to a corresponding demand instance.

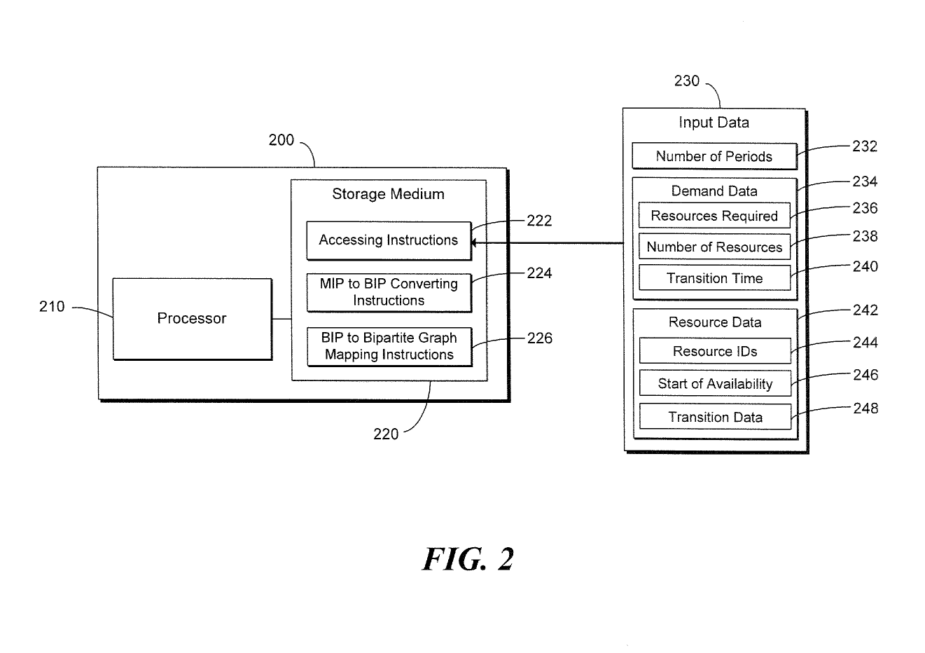

FIG. 2 is a block diagram of an example of a resource matching system 200 including a machine-readable storage medium 220 encoded with instructions for optimizing a resource matching model based on a set of input data 230. As illustrated, resource matching system 200 may include processor 210, storage medium 220 and may access a set of input data 230 from a machine-readable storage medium.

As with processor 110, processor 210 of FIG. 2 may be a central processing unit (CPU), a semiconductor-based microprocessor, or any other hardware device suitable for retrieval and execution of instructions stored in machine-readable storage medium 220. In particular, processor 210 may fetch, decode, and execute instructions 222, 224, 226 from machine-readable storage medium 220 to implement the functionality described in detail below.

Accessing instructions 222 may access input data 230 for a mixed integer programming (MIP) model, as described in detail above in connection with accessing instructions 122 of FIG. 1. In particular, the input data 230 may include general data, demand data 234, and resource data 242.

As illustrated in FIG. 2, the general input data may identify a number of time periods 232 for which assignment of resources to specific demand instances is to occur. For example, when the MIP model relates to assignment of employees to particular jobs or tasks, number of periods 232 may be an integer indicating a number of discrete time periods to be considered (e.g., two weeks each, one month each, etc.). In some embodiments, each of these time periods may then be abstracted as a positive integer (e.g., time periods 1, 2, 3, etc.). As described in further detail below, the resources may then be assigned to demand instances during periods in which the resources are available.

Demand data 234 may include an identification of the resource 236, a number of resources 238 required to satisfy the particular demand during each time period, and a transition time 240 required to convert a particular resource to satisfy the demand. The identification of the resource 236 may be any unique identifier associated with one of the resources, such as an integer, a name, etc. As one example, when the demand is a patient desiring to schedule a visit with a doctor, identification 236 may be a service provider ID for the requested doctor. It should be noted, however, that the identification of resources required 236 need not identify the resource itself. For example, when the demand instance is fulfillment of a job, resource required 236 may identify a particular skill, which, in turn, may be possessed by one or more of the employees (i.e., the resources).

Number of resources 238 may, for example, identify a total number of resources required to fulfill the demand during each time period 232 and may therefore include n non-negative integers, where n is equal to the number of time periods. Transition time 240 (also referred to as lead time) may identify a number of time periods required to convert a resource that cannot currently satisfy a particular demand to a resource that is able to satisfy the demand. For example, if the demand is a particular job skill that an employee does not currently possess, transition time 240 may identify the amount of time required to train the employee for that job skill. Similarly, if a demand is a customer order for a custom product that a vendor does not carry, transition time 240 may identify the amount of time required to modify an in-stock product to the specifications of the custom product. Other suitable transition times will be apparent to those of skill in the art depending on the context of the particular problem.

Resource data 242 may describe each resource with resource identification 244, start of availability 246, and transition data 248. Resource ID 244 may be any value that uniquely identifies an available resource, such as an integer, a string, etc. For example, when resource data 242 relates to a group of employees, resource ID 244 may identify each employee using, for example, an employee ID or a social security number. Start of availability 246 may identify a time period 232 at which the resource first becomes available for assignment to a particular demand. Finally, transition data 248 may identify, for each resource, whether the resource may be converted to satisfy a different type of demand.

MIP to BIP converting instructions 224 may convert the MIP model into a BIP model by redefining input data 230 to corresponding unary data. To convert the MIP model into a corresponding BIP model, each demand instance in demand data 234 may be redefined such that each variable corresponding to a demand instance may be expressed as one of two possible values. Similarly, each resource in resource data 242 may be redefined such that each variable corresponding to a resource may be expressed as one of two possible values.

As an example, for each demand instance for which a number of resources required 238 is greater than one, MIP to BIP converting instructions 224 may create a number of demand instances, each requiring one resource 236. Similarly, MIP to BIP converting instructions 224 may create multiple resource instances for each resource that may satisfy more than one demand simultaneously.

In addition, MIP to BIP converting instructions 224 may also determine the availability of each resource during all time periods. As noted above, in some embodiments, resource data 242 identifies the start of availability 246 for each resource, but does not identify the availability of each resource during each time period. Accordingly, in such embodiments, MIP to BIP converting instructions 224 may assume that, once a resource becomes available, it will remain available for all time periods. Accordingly, the availability (AV) of each resource (r) during each time period (t) may be expressed in terms of start of availability (S) 246 as:

$${AV}_{r , t} = {\sum }_{τ = 1}^{t} {S}_{r , τ}$$

BIP to bipartite graph mapping instructions 226 may then map the unary data into a corresponding bipartite graph. More specifically, using the unary data determined by converting instructions 224, mapping instructions 226 may create a graph containing two sets of nodes, one set corresponding to the resources and one set corresponding to the demand instances.

In order to determine whether a particular resource may be allocated to satisfy a particular demand, BIP to graph mapping instructions 226 may first determine a start time of each single demand instance in the unary data. As described above, in some embodiments, number of resources 238 may identify a total number of resources required during each time period. Accordingly, in such embodiments, instructions 126 may set the start time for each instance in the unary data based on an assumption that, once a demand is required, it remains required for all time periods. Thus, as an example, if a particular demand instance required two total resources at t=1, three at t=2, and six at t=3, the start time would be t=1 for two unary resources, t=2 for one unary resource, and t=3 for three unary resources. It should be noted, however, that in some embodiments, the start time of each demand instance may be obtained as part of demand data 234 without the need for such a determination.

Mapping instructions 226 may then create a plurality of edges, with each edge extending between a node in the set of single resources and a node in the set of single demand instances. Each of the created edges may correspond to a decision variable in the BIP model and may represent a potential allocation of a resource to a corresponding demand instance that may be satisfied by that resource. Accordingly, when a matching is determined for the created graph, a selected edge may correspond to a value of “1” for the binary decision variable, while a unselected edge may correspond to a value of “0.”

As an example, assume that the decision variables for a particular BIP model represent the following: (1) whether a particular resource is assigned to a particular demand at a given time; (2) whether a particular resource is converted to satisfy a particular demand at a given time; (3) whether a particular resource may be acquired in the future to satisfy the particular demand; and (4) whether the particular demand cannot be fulfilled. Mapping instructions 226 may then determine, for each pair (r, d), where r is a node in the set of resources and d is a node in the set of demand instances, whether to create an edge between r and d.

Mapping instructions 226 may, for example, create edges for each pair (r,d) in the following order of preference: (1) r is available for allocation to satisfy d at the start time; (2) r is available for allocation to satisfy d after the start time; (3) r is able to be converted to be available for allocation to satisfy d at the start time; and (4) r is able to be converted to be available for allocation to satisfy d after the start time. In addition, mapping instructions 226 may create, for each demand instance, an edge from a node in a third set that represents a resource not currently available that is obtainable in the future to satisfy d (e.g., by hiring, ordering, etc.). Finally, mapping instructions 226 may create, for each demand instance, an edge from a node in a fourth set that indicates that no resource is available to meet the demand.

In addition, in some embodiments, mapping instructions 226 may assign a cost to each edge in the bipartite graph. Such a cost may be based on a plurality of predetermined constants, with one or more constants used for each edge. For example, edges in set (1) may be assigned an allocation cost, while edges in set (2) may be assigned the allocation cost in addition to any penalties for late fulfillment. Similarly, edges in set (3) may be assigned a cost for conversion, while edges in set (4) may be assigned the cost for conversion in addition to any penalties for late fulfillment. Edges from nodes in the third set may be assigned an acquisition cost, plus any penalties for late fulfillment, if applicable. Finally, edges from nodes in the fourth set may be assigned penalties for the entire period, as no resource is available to meet the demand.

After mapping instructions 226 have created a bipartite graph and assigned any associated costs, any of a number of methods may be used to find a minimum-cost (or maximum-cost) matching for the graph, which may comprise a plurality of edges without common vertices. Examples of suitable methods include the Kuhn-Munkres Algorithm (or Hungarian method), the simplex method or interior point method to solve Linear Programming problems genetic algorithms, or any other method for solving such problems. In this manner, each selected edge in the matching may correspond to a value of “1” for the corresponding binary decision variable.

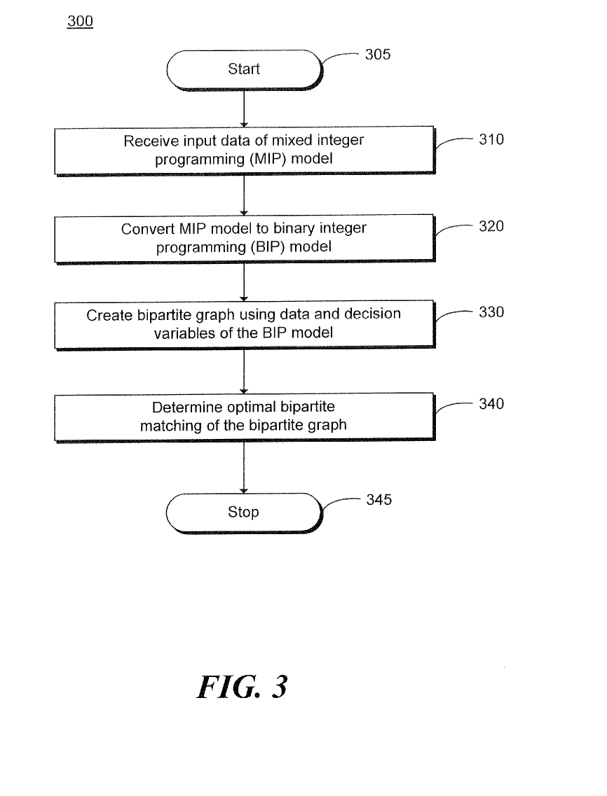

FIG. 3 is a flowchart of an example of a method 300 for optimizing a resource matching model. Although execution of method 300 is described below with reference to the components of resource matching system 100, other suitable components for execution of method 300 will be apparent to those of skill in the art. Method 300 may be implemented in the form of executable instructions stored on a machine-readable storage medium, such as machine-readable storage medium 120 of FIG. 1.

Method 300 may start in block 305 and proceed to block 310, where resource matching system 100 may access or otherwise receive input data for a mixed integer programming (MIP) model. The input data used in the MIP model may include resource data describing a number of resources and demand data describing demand instances for the resources. Resource matching system 100 may obtain the input data by accessing a connected database, reading from one or more local or remote machine-readable storage media, receiving user input, or through any other means that will be apparent to those of skill in the art.

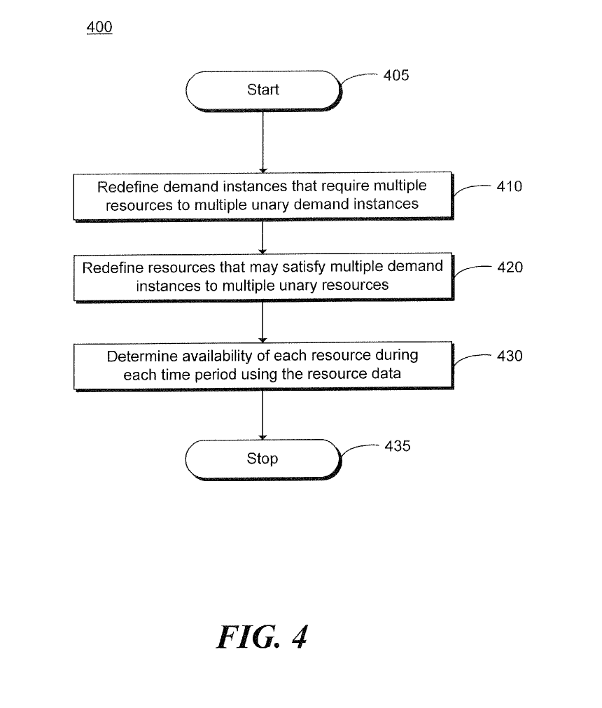

After access of the input data, method 300 may then proceed to block 320, where resource matching system 100 may convert the MIP model into a corresponding binary integer programming (BIP) model. In order to convert the MIP model into a BIP model, resource matching system 100 may redefine the input data to corresponding unary data. For example, resource matching system 100 may redefine resources and demand instances, such that each decision variable used in the MIP model may be expressed as a decision variable in the BIP model as one of two possible values. An example embodiment of additional processing that may be performed in block 320 is described in further detail below in connection with FIG. 4.

After conversion of the MIP model to a corresponding BIP model, method 300 may proceed to block 330, where resource matching system 100 may create a bipartite graph using the unary input data and decision variables of the BIP model. In particular, resource matching system 100 may create a graph coupling nodes representing resources with corresponding nodes representing demand instances. The edges in the created graph may each correspond to a decision variable in the BIP model and may represent a potential allocation of a resource to a demand instance that may be fulfilled by that resource. Resource matching system 100 may also associate a value with each edge representing a cost for allocating the resource to the connected demand instance.

After creation of the bipartite graph, method 300 may then proceed to block 340, where resource matching system 100 may determine an optimal bipartite matching of the created graph. In particular, resource matching system 100 may launch execution of a suitable method for determining a minimum or maximum cost matching. As described in detail above, such methods will be apparent to those of skill in the art. In the resulting matching, each selected edge may correspond to assignment of a particular resource to a corresponding demand instance. Method 300 may then proceed to block 345, where method 300 may stop.

FIG. 4 is a flowchart of an example of a method 400 for converting a mixed integer programming model to a corresponding binary integer programming model. Although execution of method 400 is described below with reference to the components of resource matching system 200, other suitable components for execution of method 400 will be apparent to those of skill in the art. Method 400 may be implemented in the form of executable instructions stored on a machine-readable storage medium, such as storage medium 220 of FIG. 2.

Method 400 may start in block 405 and proceed to block 410, where resource matching system 200 may redefine any demand instances that require multiple resources to multiple single demand instances. As one example, in a job assignment problem, each job may include multiple tasks and therefore require multiple employees. In such an example, in block 410, resource matching system 200 may redefine each job requiring n tasks to n jobs, each requiring one task. A similar process may be executed, for example, when each single individual that uses a dating website may be matched with a number of potential partners, when a person desires to adopt multiple pets, or in any analogous situation.

Method 400 may then proceed to block 420, where resource matching system 200 may redefine each resource that may satisfy multiple demand instances to multiple unary resources. Continuing with the job assignment example, suppose that each employee may simultaneously work on n tasks. In this example, in block 420, resource matching system 200 may redefine each employee capable of handling n tasks to n instances of that employee, each capable of handling a single task. A similar process may be executed, for example, in a class selection lottery in which each class has a predefined student capacity, in a workforce distribution problem in which each building may hold multiple employees, or in any analogous situation.

After conversion of demand instances and resources, method 400 may proceed to block 430, where resource matching system 200 may determine the availability of each resource during each time period. In some embodiments, the resource data identifies the start of availability for each resource, but does not identify the availability of each resource during each time period. Accordingly, as described above in connection with MIP to BIP converting instructions 224, the availability (AV) of each resource (r) during each time period (t) may be expressed in terms of the start of availability (S) as:

$${AV}_{r , t} = {\sum }_{τ = 1}^{t} {S}_{r , τ}$$

Alternatively, in some embodiments, the availability of each resource during each time period may be provided as input, thereby avoiding the conversion described above. After execution of block 430, the MIP model may be fully converted to a corresponding BIP model. Method 400 may then proceed to block 435, where method 400 may stop.

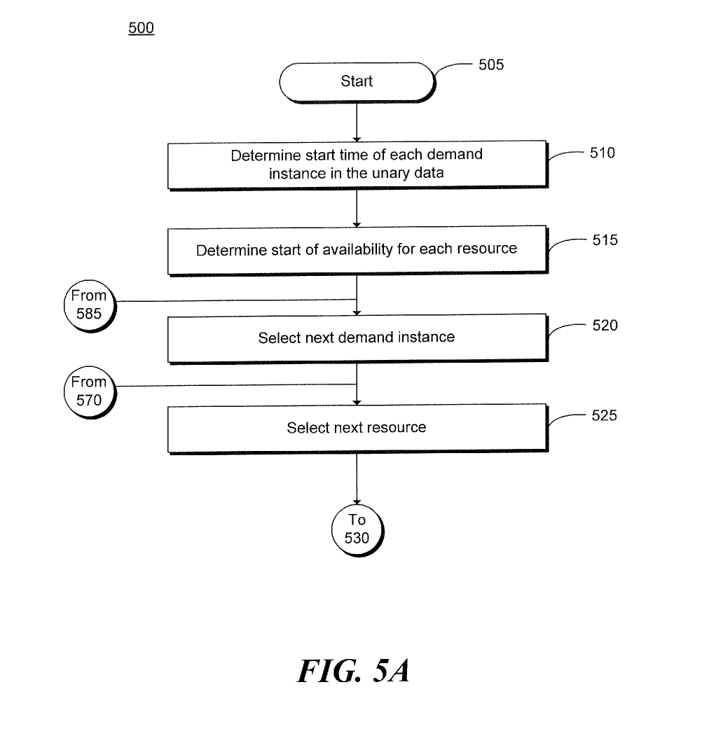

FIGS. 5A & 5B are flowcharts of an example of a method 500 for creating a bipartite graph using a binary integer programming model. Although execution of method 500 is described below with reference to the components of resource matching system 200, other suitable components for execution of method 500 will be apparent to those of skill in the art. Method 500 may be implemented in the form of executable instructions stored on a machine-readable storage medium, such as machine-readable storage medium 220 of FIG. 2.

Method 500 may start in block 505 and proceed to block 510, where resource matching system 200 may determine the start time of each demand instance using the unary data. In some embodiments, number of resources 238 may identify a total number of resources required to satisfy a particular demand during each time period, rather than identifying a required start time for each resource. In such embodiments, as described above in connection with BIP to graph mapping instructions 226, resource matching system 200 may set the start time for each instance in the unary data based on an assumption that, once a demand is required, it remains required for all time periods. It should be noted, however, that in some embodiments, the start time of each demand instance may be obtained as part of demand data 234 without the need for such a determination.

Method 500 may then proceed to block 515, where resource matching system 200 may determine the start of availability for each resource. The start of availability may be determined, for example, by identifying the first time period for which the availability of the resource is “1.” Alternatively, a separate data structure may contain the start of availability for each resource.

Method 500 may then proceed to block 520, where the construction of graph edges may begin with a next demand instance. For example, in the first iteration of block 520, resource matching system 200 may simply select the first demand instance from the unary data. In subsequent iterations, resource matching system 200 may select a next demand instance from the unary data for processing. Similarly, in block 525, resource matching system 200 may select a resource from the unary data for processing and, in subsequent iterations, select a next resource from the unary data. After selection of a particular demand instance and a particular resource, method 500 may proceed to block 530 of FIG. 5B.

Referring now to FIG. 5B, in block 530, resource matching system 200 may determine whether the resource selected in block 525 may satisfy the demand instance selected in block 520. Resource matching system 200 may make this determination in a number of ways. As one example, when the demand instances directly identify a required resource, resource matching system 200 may simply compare an identifier of the resource to a resource identifier specified for the demand instance and, when the identifiers match, determine that the resource may satisfy the demand instance. Alternatively, resource matching system 200 may determine whether the resource may satisfy the demand instance by accessing one or more data structures to determine the attributes of a particular resource, and then determine whether the demand instance would be satisfied by the particular resource based on those attributes. As a more specific example, when the demand instance is a particular job and the resources are employees, the attributes may relate to jobs for which the employee is qualified.

When it is determined in block 530 that the resource satisfies the demand, method 500 may proceed to block 535, where resource matching system 200 may determine whether the resource may satisfy the demand on time. In making this determination, resource matching system may compare the start time of the demand determined in block 510 with the start of availability of the resource determined in block 515. When the start of availability of the resource is at or before the start time of the demand, resource matching system 200 may determine that the resource may satisfy the demand on time.

When it is determined in block 535 that the resource may satisfy the demand on time, method 500 may proceed to block 540, where resource matching system 200 may create an on time edge in the bipartite graph between the resource and the demand, indicating that the resource may potentially be allocated to satisfy the demand. Resource matching system 200 may also associate any costs with the edge, such as a cost of allocating the resource to the demand. These costs may later be used in determining an optimal bipartite matching of the graph. Method 500 may then proceed to block 570.

Alternatively, when it is determined in block 535 that the resource potentially satisfies the demand, but is unable to satisfy the demand on time, method 500 may proceed to block 545. In block 545, resource matching system 200 may create a late edge in the bipartite graph between the resource and the demand, indicating that the resource may potentially be allocated to satisfy the demand, but may only do so after the start time. Resource matching system 200 may also associate any costs with the edge, such as a cost of allocating the resource in addition to a late penalty equal to the number of periods for which the demand would go unsatisfied, times a per-period penalty. Method 500 may then proceed to block 570.

When it is determined in block 530 that the resource cannot satisfy the demand, method 500 may proceed to block 550, where resource matching system 200 may determine whether the resource may be converted or otherwise transitioned to satisfy the demand. In making this determination, resource matching system 200 may, for example, access a data structure indicating the ability of a particular resource to be transitioned to the resource required by the demand instance.

When it is determined that the resource may be transitioned to satisfy the demand, method 500 may proceed to block 555, where resource matching system 200 may determine whether a transition could occur such that the transitioned resource is available on time. In making this determination, resource matching system may compare the start time of the demand determined in block 510 with the start of availability of the resource determined in block 515 plus a number of periods required for the transition. The number of periods required for the transition may be determined, for example, by accessing a data structure indicating the time required to transition a particular resource type to another resource type. When the start of availability of the transitioned resource is at or before the start time of the demand, resource matching system 200 may determine that the resource may be transitioned to satisfy the demand on time.

When it is determined in block 555 that the resource may be transitioned to satisfy the demand on time, method 500 may proceed to block 560, where resource matching system 200 may create an on time transition edge in the bipartite graph between the resource and the demand, indicating that the resource may potentially be transitioned to satisfy the demand. Resource matching system 200 may also associate any costs with the edge, such as a cost of transitioning the resource. Method 500 may then proceed to block 570.

Alternatively, when it is determined in block 535 that the resource may be transitioned to satisfy the demand, but would be unable to be transitioned on time, method 500 may proceed to block 565. In block 565, resource matching system 200 may create a late transition edge in the bipartite graph between the resource and the demand, indicating that the resource may potentially be transitioned to satisfy the demand, but that the transition would be completed after the start time. Resource matching system 200 may also associate any costs with the edge, such as a cost of transitioning the resource in addition to a late penalty equal to the number of periods for which the demand would go unsatisfied, times a per-period penalty. Method 500 may then proceed to block 570.

In block 570, resource matching system 200 may determine whether there are additional resources to be processed for the currently-selected demand. If so, method 500 returns to block 525 of FIG. 5A, where resource matching system 200 selects a next resource for processing. Alternatively, if all resources have been processed for the current demand, method 500 may proceed to block 575.

In block 575, resource matching system 200 may create an edge to the demand instance from a node representing a resource that is obtainable in the future to satisfy the corresponding demand (e.g., a new hire, a special order, etc.). Resource matching system 200 may also associate a cost with the new edge, such as a cost of obtaining the resource. Method 500 may then proceed to block 580.

In block 580, resource matching system 200 may create an edge to the demand instance from a node representing a resource that is not available. In other words, this edge may represent a situation in which there is no available resource that may satisfy the demand, be transitioned to satisfy the demand, or be obtained in some other manner. Resource matching system 200 may also associate a cost with the new edge, such as a total number of periods for which the demand is required times a per-period penalty.

Method 500 may then proceed to block 585, where resource matching system 200 may determine whether there are additional demand instances for which processing is required. When there are additional demand instances, method 500 may return to block 520 of FIG. 5A. Alternatively, when all demand instances have been processed, method 500 may proceed to block 590, where method 500 may stop.

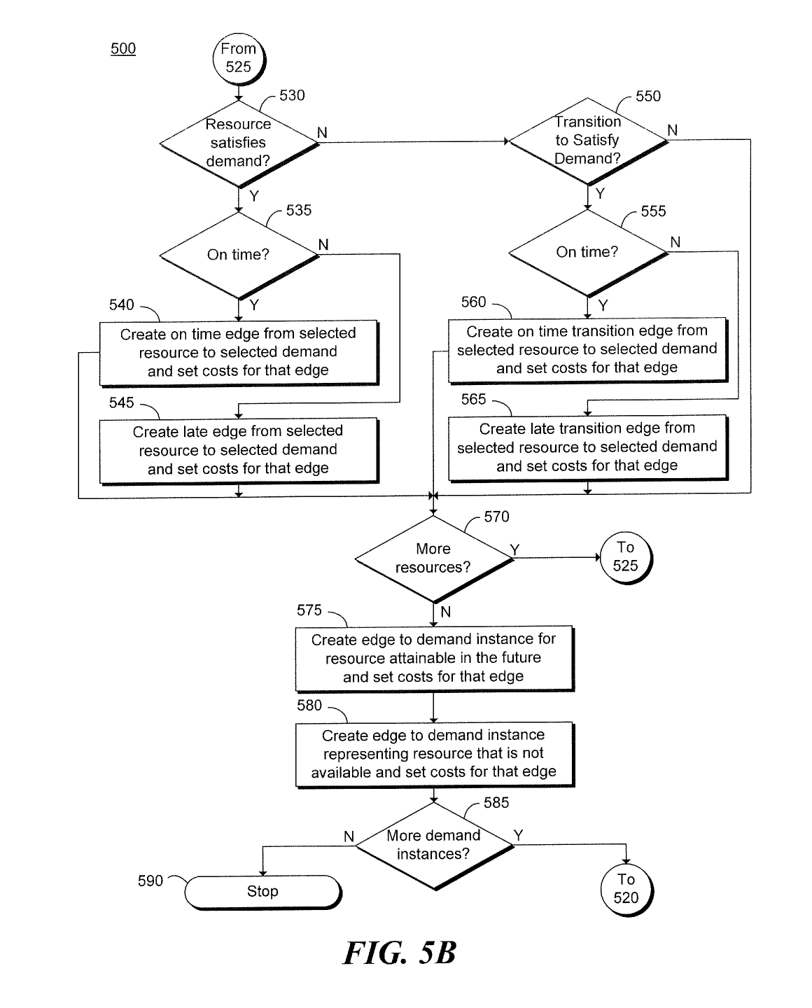

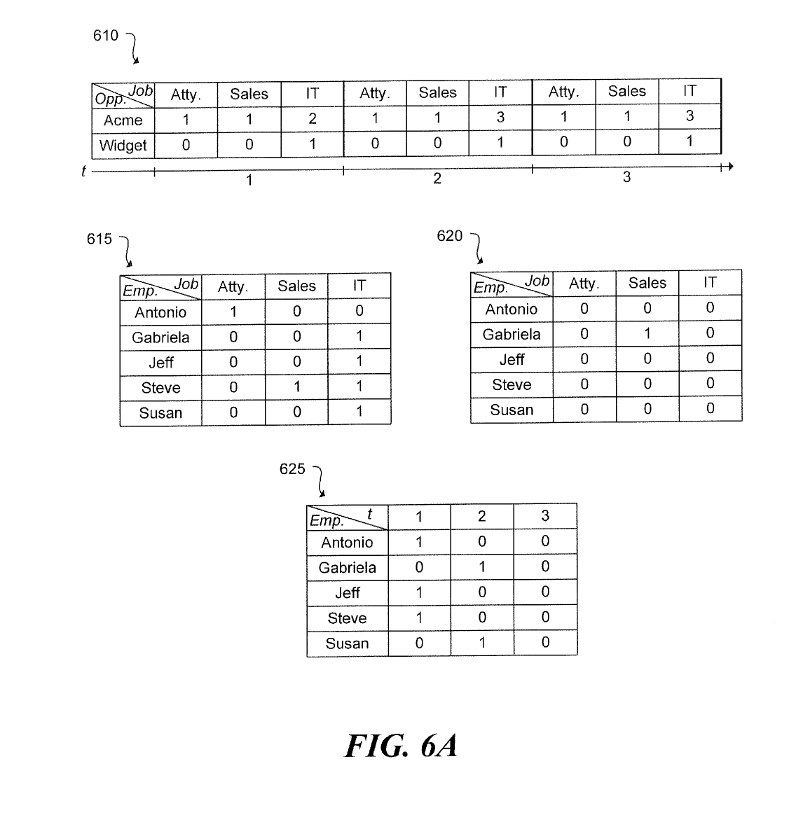

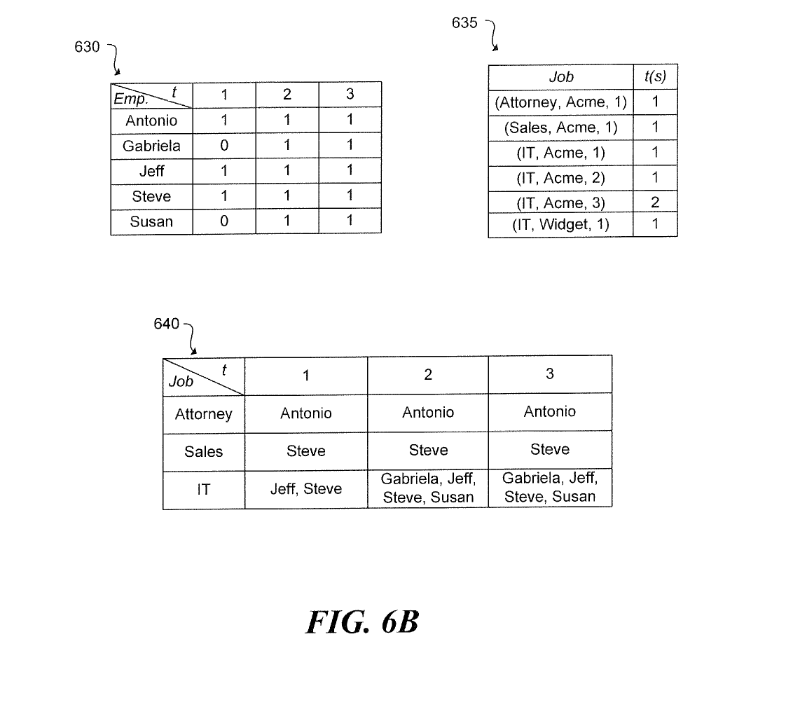

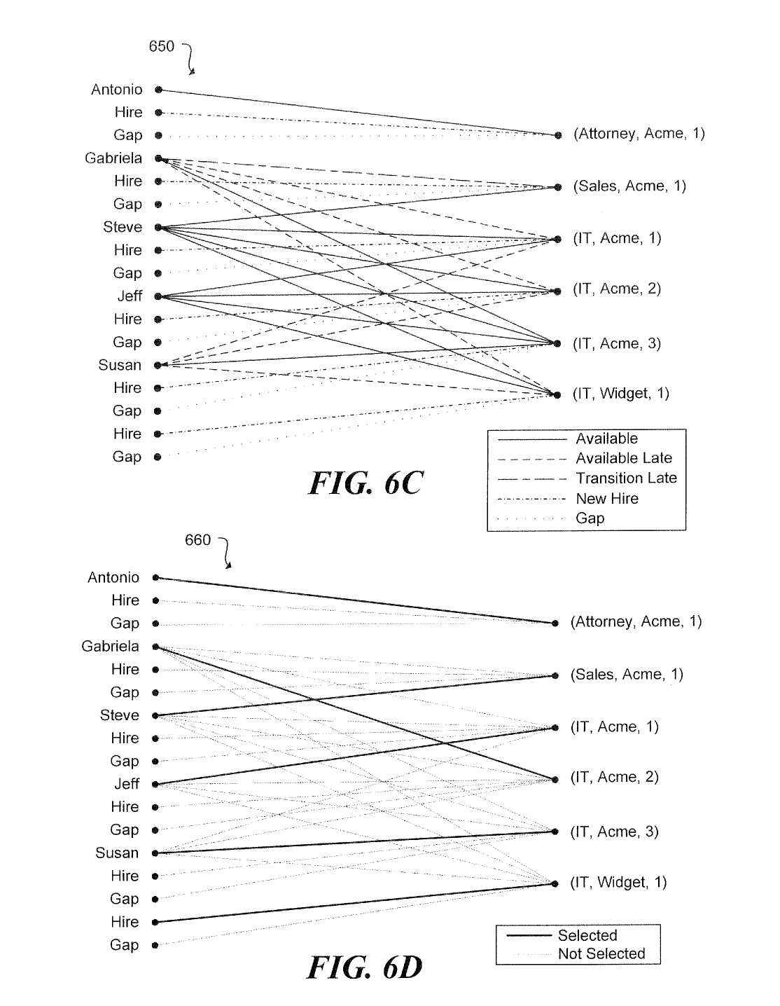

Having described various example embodiments, an example application of such embodiments will now be presented with reference to FIGS. 6A-6D. The following example relates to a job assignment problem in which a number of employees (resources) are to be assigned to jobs to be filled (demand instances) for a number of opportunities spanning a number of time periods. In solving this problem, the goal is to develop an employee allocation, training, and hiring plan that capitalizes on as many opportunities as possible, while minimizing costs to the company.

FIG. 6A is an example data set of a mixed integer programming model. The data set may include a job requirement table 610, an employee qualification table 615, an employee transition table 620, and an employee release table 625. In particular, each table represents a portion of the input data used in the original mixed integer programming model.

Job requirement table 610 may contain demand data that identifies the headcount requirements (REQ) for a particular job, j, of opportunity, i, during time period, t. Thus, as an example, REQ_{IT, Acme, 2}=3, which indicates that three information technology (IT) employees are required to service the Acme opportunity during the second time period.

Employee qualification table 615 may contain resource data that identifies the qualifications (Q) of each employee, w, for a particular job, j. As illustrated, an entry of “1” may indicate that the employee is qualified for a particular job, while an entry of “0” may indicate that the employee is not qualified for the job. Thus, as an example, Q_{Jeff, Sales}=0, which indicates that Jeff is not qualified for a sales position.

Employee transition table 620 may contain resource data indicating whether each employee, w, is qualified for transitioning (QT) to a job, j, for which he or she is not currently qualified. As illustrated, an entry of “1” may indicate that the employee is qualified for a transition to a particular job, while an entry of “0” may indicate that the employee is not qualified for the transition. Thus, as an example, QT_{Gabriela, Sales}=1, which indicates that Gabriela, who is currently qualified to work only in IT, may be transitioned to a sales position. In an associated data structure, the input data may also include a transition lead time period indicating a number of time periods required to transition a particular employee to a particular job by, for example, training the employee, transferring the employee to a new location, or otherwise changing the current state of the employee.

Employee release table 625 may contain additional resource data that identifies the release time period (R) for each employee. In particular, the entry of “1” in a particular row indicates the time at which each employee is released from a previous job and therefore becomes available. Thus, as an example, R_{Gabriela, 2}=1, indicating that Gabriela becomes available for assignment to a job at time period 2.

It should be noted that additional input data may be included, depending on the context of the particular job assignment problem. For example, the input data may include data indicating an amount of time required to hire a new employee for each job type, predefined allocations of particular employees to particular jobs, data regarding individuals in the hiring process, and hiring limits. In addition, for use in the objective function, the input data may also include priorities of each opportunity, a probability of winning the particular opportunity, and costs associated with loss of an opportunity, training, hiring, allocation, etc.

In addition to the illustrated input data, the MIP model may include a number of decision variables representing, for example, whether an employee has been allocated or transitioned to a particular job, a number of additional employees required for a particular job, a number of new hires in an inventory and assigned to each job, and whether a job cannot be filled (i.e., there is a gap). Furthermore, the MIP model may include a number of constraint equalities or inequalities representing requirements of any job assignment solution in terms of the variables. For example, constraints might indicate that each employee may only be assigned to one job, that an employee must be qualified or able to be transitioned to be assigned to a job, etc. Other suitable variables and constraints will be apparent to those of skill in the art based on the particular problem.

Finally, the MIP model may include an objective function specifying a function to be minimized in terms of the costs and variables. A solution to the MIP model is a set of values for the variables that satisfies all constraints, while minimizing the total cost as determined using the objective function. As will be apparent to those of skill in the art, solving the MIP model detailed above is time intensive and requires a large amount of processing resources. Accordingly, using the embodiments described in detail herein, one may convert the MIP model into a corresponding BIP model, and then convert the BIP model into a bipartite graph containing a number of edges.

FIG. 6B is an example data set of a binary integer programming model corresponding to the mixed integer programming model of FIG. 6A. In some embodiments, the data illustrated in FIG. 6B may be obtained through execution of MIP to BIP converting instructions 124, 224, block 320 of FIG. 3, or method 400 of FIG. 4. The data set may include employee availability table 630, start time table 635, and job fulfillment table 640.

Employee availability table 630 may contain resource data that identifies the availability (AV) for each employee, j, during each time period, t. As detailed above in connection with MIP to BIP converting instructions 224, each entry in availability table 630 may be a running total of a corresponding row in employee release table 625. Thus, as an example, in release table 625, the row for Susan indicates that she will be released from a previous job at t=2. Thus, in availability table 630, the values for times t=2 and t=3 are both “1,” indicating that Susan is available for assignment during both time periods.

Start time table 635 may contain data identifying a particular job and a corresponding start time. As illustrated in the first column, for each job in the MIP model with a headcount of n, the BIP model contains n entries. Thus, because the maximum headcount for the Acme IT job is 3 in the MIP model, three distinct entries exist in the BIP model. The second column of start time table 635 may indicate the time period at which the particular job is first required. As also described in further detail above in connection with MIP to BIP converting instructions 224, the values included in the second column of start time table 635 may be determined using job requirement table 610 based on the assumption that, once a job is required, it remains required for all time periods.

Job fulfillment table 640 may identify all employees who are qualified and available (QE) to satisfy a particular job, j, at a particular time, t. In particular, a given entry QE_{j,t} may include all employees, w, for which AV_{w, t}=1 (see table 630) and QE_{w,j}=1 (see table 615). A job transition table may be generated in a similar manner using transition table 620, availability table 630, and the transition time received as input. In this case, assuming a transition time of one period, the only entry in such a table would be Gabriela for Sales at t=3.

FIG. 6C is an example bipartite graph 650 including a plurality of edges generated using the binary integer programming model of FIG. 6B. In some embodiments, the data illustrated in FIG. 6B may be obtained through execution of BIP to bipartite graph mapping instructions 126, 226, block 330 of FIG. 3, and method 500 of FIGS. 5A and 5B.

Bipartite graph 650 includes a first set of edges connecting each employee to each job for which the employee is available at a start time of the job and is qualified for the job. As an example, referring to FIG. 6B, the edges to include may be determined by selecting a particular job from table 635, determining the start time from table 635, then accessing table 640 to identify all employees who are available for the particular job at the start time. Thus, as an example, for the job, (Attorney, Acme, 1), t(s) is 1 and, in table 640, Antonio is the only attorney available at this start time. Accordingly, graph 650 includes an available on time edge between Antonio and (Attorney, Acme, 1).

Bipartite graph 650 also includes a second set of edges connecting each employee to each job for which the employee is available after the start time of the job and is qualified for the job. As an example, referring again to FIG. 6B, the edges to include may be determined by selecting a particular job from table 635, determining the start time from table 635, then accessing table 640 to identify all employees who are qualified and available for the particular job after, but not at, the start time. Thus, as an example, for the job, (IT, Acme, 1), t(s) is 1 and, in table 640, Gabriela and Susan are qualified for IT positions, but are not available until t=2. Accordingly, graph 650 includes one available late edge between Gabriela and (IT, Acme, 1), and another between Susan and (IT, Acme, 1).

Bipartite graph 650 may also include a third set of edges connecting each employee to each job for which the employee is available for transitioning by the start time of the job. As detailed above in connection with FIG. 6B, in this example, Gabriela is the only employee who may be transitioned, but she will not be available if transitioned until t=3 (the start of her availability at t=2 plus the training period of 1). Thus, although Gabriela may be transitioned to sales, the third set of edges is null in this example, as the only sales job is (Sales, Acme, 1), for which t(s) is 1.

In addition, bipartite graph 650 may include a fourth set of edges connecting each employee to each job for which the employee is available for transitioning after the start time of the job. In this example, because Gabriela may be transitioned to (Sales, Acme, 1) at t=3, graph 650 may include a late transition edge between these two nodes.

Bipartite graph 650 may also include a fifth set of edges, each between a particular job and a node representing an employee to be hired for that job. Thus, as illustrated in graph 650, because there are six total jobs to be filled, there are also six total new hire nodes, each connected to one of the jobs. Finally, bipartite graph 650 may include a sixth set of edges, each between a particular job and a node indicating that the particular job cannot be filled (i.e., there is a “gap”). As with the new hire edges, graph 650 includes six gap edges, each coupled to a corresponding node representing the inability to fill the position.

In addition to creation of the edges, the procedure for mapping of the BIP model to a corresponding bipartite graph may include assignment of costs to each edge. For example, for an on time edge, the associated cost may be the cost of allocating the employee to the job (e.g., based on the employee's salary or qualifications), while the costs associated with a late edge may be the cost of allocation, plus any penalties due to the unfulfilled time periods. In addition, for on time transition edges, the cost may be a transitioning cost (e.g., cost for training the employee for a new role), while late transition edges would also include late penalties. Finally, for new hire edges, the cost may include the cost of hiring (e.g., recruiting, interviewing, etc.), plus late penalties, if any. Finally, for gap edges, the cost may include any revenue loss due to failure to fill the position.

FIG. 6D is an example bipartite graph illustrating one matching 660 of the bipartite graph 650 of FIG. 6C. As detailed above, any method suitable for finding a lowest-cost matching may be used to determine the edges that combine for a lowest-possible cost. As illustrated in FIG. 6D, one possible solution to the job assignment example detailed in FIGS. 6A-6C is as follows: assign Antonio to (Attorney, Acme, 1); assign Gabriela to (IT. Acme, 2); assign Steve to (Sales. Acme, 1); assign Jeff to (IT, Acme, 1); assign Susan to (IT, Acme, 3); and hire a new employee for (IT, Widget, 1).

According to the foregoing, various example embodiments enable optimization of a resource matching model. In particular, example embodiments allow for conversion of a mixed integer programming (MIP) model to a corresponding binary integer programming (BIP) model. The BIP model may then be mapped to a number of edges in a bipartite graph along with any associated costs. An optimal matching may then be determined using a number of highly-efficient methods, thereby providing a resource matching solution without the processing time and complexity typically encountered when solving MIP models.

We claim:

1. A method for optimizing a resource matching model, the method comprising:
accessing, in a resource matching system, input data for a mixed integer programming (MIP) model, the input data including resource data describing resources and demand data describing demand instances for the resources;
converting the MIP model to a binary integer programming (BIP) model by redefining the input data to unary data; and
mapping the BIP model to a bipartite graph using the unary data, the bipartite graph comprising:
a plurality of nodes including a first set of nodes corresponding to the resources and a second set of nodes corresponding to the demand instances, and
a plurality of edges corresponding to decision variables of the BIP model, each edge representing a potential allocation of a resource in the first set of nodes to a demand instance in the second set of nodes.

2. The method of claim 1, wherein:
the demand data comprises a value for each demand instance indicating a number of resources required to satisfy the demand instance, and
converting the MIP model to the BIP model further comprises redefining each demand instance requiring a plurality of resources to a corresponding plurality of unary demand instances requiring a single resource.

3. The method of claim 2, wherein:
the input data further includes a number of time periods for which resources are to be allocated to the demand, and
the resource data includes an indication of a time period at which each resource becomes available.

4. The method of claim 3, wherein converting the MIP model to the BIP model further comprises:
determining availability of each resource during each time period.

5. The method of claim 4, wherein mapping the BIP model to the bipartite graph further comprises:
determining a start time of each demand instance in the unary data.

6. The method of claim 5, wherein mapping the BIP model to the bipartite graph further comprises:
creating an edge to each node in the second set from each node in the first set for which the corresponding resource is available for allocation to satisfy the corresponding demand instance at the start time.

7. The method of claim 5, wherein mapping the BIP model to the bipartite graph further comprises:
creating an edge to each node in the second set from each node in the first set for which the corresponding resource is available for allocation to satisfy the corresponding demand after the start time.

8. The method of claim 5, wherein mapping the BIP model to the bipartite graph further comprises:
creating an edge to each node in the second set from each node in the first set for which the corresponding resource is able to be converted to be available for allocation to satisfy the corresponding demand instance at the start time; and
creating an edge to each node in the second set from each node in the first set for which the corresponding resource is able to be converted to be available for allocation to satisfy the corresponding demand instance after the start time.

9. The method of claim 5, wherein mapping the BIP model to the bipartite graph further comprises:
creating an edge to each node in the second set from a corresponding node in a third set, each node in the third set representing a resource not currently available that is obtainable in the future to satisfy the corresponding demand.

10. The method of claim 5, wherein mapping the BIP model to the bipartite graph further comprises:
creating an edge to each node in the second set from a corresponding node in a fourth set, each of the edges indicating that a resource is not available to satisfy the corresponding demand.

11. A machine-readable storage medium encoded with executable instructions for optimizing a resource matching model, the machine-readable medium comprising:
instructions for converting input data of a mixed integer programming (MIP) model to corresponding unary input data of a binary integer programming (BIP) model;
instructions for mapping the converted unary input data of the BIP model to a bipartite graph comprising a first set of nodes corresponding to available resources and a second set of nodes corresponding to demand for the resources; and
instructions for creating a plurality of edges in the bipartite graph, each edge connecting a first node in the first set to a second node in the second set, wherein each edge is determined using the converted unary input data and corresponds to a decision variable of the BIP model.

12. The machine-readable storage medium of claim 11, wherein the input data comprises:
demand data comprising an identification of at least one project, an identification of at least one job required for each project, and a number of employees required for each job during each of a number of time periods, and
resource data comprising, for each employee, an identification of the employee, jobs for which the employee is qualified, a time period at which the employee first becomes available, jobs to which the employee is able to be transitioned, and a transition lead time period for each job to which the employee is able to be transitioned.

13. The machine-readable storage medium of claim 12, wherein the instructions for converting the input data of the MIP model to the unary input data of the BIP model comprise:
instructions for generating, for each job that requires a plurality of employees, a corresponding plurality of unary job instances.

14. The machine-readable storage medium of claim 12, wherein the instructions for converting the input data of the MIP model to the unary input data of the BIP model comprise:
instructions for generating an availability data structure using the time period at which each employee first becomes available, each entry of the availability data structure indicating whether a particular employee is available during a particular time period.

15. The machine-readable storage medium of claim 12, wherein the instructions for creating the plurality of edges in the bipartite graph comprise:
instructions for creating a first set of edges, wherein each edge in the first set connects a particular job and a particular employee who is available at a start time of the particular job and is qualified for the particular job; and
instructions for creating a second set of edges, wherein each edge in the second set connects a particular job and a particular employee who is available after a start time of the particular job and is qualified for the particular job.

16. The machine-readable storage medium of claim 15, wherein the instructions for creating the plurality of edges in the bipartite graph further comprise:
instructions for creating a third set of edges, wherein each edge in the third set connects a particular job and a particular employee who is available to be transitioned to the particular job by a start time of the particular job; and
instructions for creating a fourth set of edges, wherein each edge in the fourth set connects a particular job and a particular employee who is available to be transitioned to the particular job after a start time of the particular job.

17. The machine-readable storage medium of claim 16, wherein the instructions for creating the plurality of edges in the bipartite graph further comprise:
instructions for creating a fifth set of edges, wherein each edge in the fifth set connects a particular job to a node corresponding to an employee to be hired; and
instructions for creating a sixth set of edges, wherein each edge in the sixth set connects a particular job to a node indicating that the particular job cannot be filled.

18. The machine-readable storage medium of claim 17, wherein the instructions for creating the plurality of edges in the bipartite graph further comprise:
instructions for associating a cost with each edge in the first, second, third, fourth, fifth, and sixth sets, wherein each cost is calculated based on at least one of the employee's qualifications, a cost for transitioning, a penalty for fulfilling the job after the start time, a cost of hiring, and a revenue loss when the job cannot be filled.

19. A resource matching system comprising:
a processor; and
a machine-readable storage medium encoded with instructions executable by the processor, the instructions comprising:
instructions for accessing input data of a mixed integer programming (MIP) model, the input data including resource data describing resources and demand data describing demand instances for the resources,
instructions for converting the demand data into single demand data usable in a binary integer programming (BIP) model, wherein converting the demand data comprises conversion of each demand instance requiring a plurality of resources into a corresponding plurality of single demand instances requiring a single resource, and
instructions for creating a bipartite graph comprising a plurality of edges corresponding to decision variables of the BIP model, wherein:
each edge represents a potential allocation of a particular resource to a corresponding demand instance of the single demand data, and
each edge is associated with a corresponding cost for allocating the particular resource to the corresponding single demand instance.

20. The resource matching system of claim 19, wherein the instructions for creating the bipartite graph comprise:
instructions for creating a first set of edges, wherein the first set of edges connects each demand instance to each resource that is available to satisfy the demand instance at a start time of the demand instance;
instructions for creating a second set of edges, wherein the second set of edges connects each demand instance to each resource that is available to satisfy the demand instance after the start time;
instructions for creating a third set of edges, wherein the third set of edges connects each demand instance to each resource that is able to be converted to satisfy the demand instance by the start time of the demand instance;
instructions for creating a fourth set of edges, wherein the fourth set of edges connects each demand instance to each resource that is able to be converted to satisfy the demand instance after the start time of the demand instance;
instructions for creating a fifth set of edges, wherein the fifth set of edges connects each demand instance to a corresponding node representing a resource that may be acquired at a future time to satisfy the demand instance; and
instructions for creating a sixth set of edges, wherein the sixth set of edges connects each demand instance to a corresponding node indicating that the particular demand instance cannot be satisfied.
